(19) United States
(12) Patent Application Publication
(10) Pub. No.: US 2024/0193072 A1
(43) Pub. Date: Jun. 13, 2024

(54) AUTOSUGGESTION OF INVOLVED CODE PATHS BASED ON BUG TRACKING DATA

(71) Applicant: Red Hat, Inc., Raleigh, NC (US)

(72) Inventors: Srinivasa Bharath Kanta, Bangalore (IN); Radoslaw Adam Zarzynski, Warsaw (PL)

(21) Appl. No.: 18/077,144

(22) Filed: Dec. 7, 2022

(51) Int. Cl. G06F 11/36

(52) U.S. Cl. CPC G06F 11/3616

(57) ABSTRACT

A code path autosuggestion system retrieves, from a repository, defect data associated with a first software defect. Using the defect data, the code path autosuggestion system searches a dataset for a second software defect, the second software defect associated with the first software defect. As a result of the search, the code path autosuggestion system determines a set of regions of source code associated with the second software defect. The code path autosuggestion system uploads the set of regions of source code to the repository as candidates for patching the first software defect.

### TECHNICAL FIELD

Aspects of the present disclosure relate to software testing, and more particularly, to identifying sections of source code associated with a software defect based on their association with a previously addressed software defect.

### BACKGROUND

Software development can involve large, complex applications. Changes to the code base can introduce defects into the applications. These defects can manifest themselves in multiple locations in multiple source code files. These defects may be similar to previously addressed defects. Identification and prosecution of software defects may involve bug tracking software tools.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments without departing from the spirit and scope of the described embodiments.

FIG. 1 is an illustrative example of a code path autosuggestion architecture, in accordance with some embodiments of the disclosure.

FIG. 2 is an illustrative example of a code path autosuggestion dataset, in accordance with some embodiments of the disclosure.

FIG. 3 is a block diagram that illustrates an example code path autosuggestion architecture, in accordance with some embodiments of the disclosure.

FIG. 4 is a flow diagram of an example method of code path autosuggestion, in accordance with some embodiments of the disclosure.

FIG. 5 is a block diagram depicting an example environment for a code path autosuggestion architecture, in accordance with some embodiments of the disclosure.

FIG. 6 is a block diagram of an example computing device that may perform one or more of the operations described herein, in accordance with some embodiments of the disclosure.

### DETAILED DESCRIPTION

Bug tracking is the process of logging and monitoring bugs or errors during software testing. It is also referred to as defect tracking or issue tracking. Large systems may have hundreds or thousands of defects. Each needs to be evaluated, monitored and prioritized for debugging. In some cases, bugs may need to be tracked over a long period of time. Defect resolution, or bug fixing, can be a significant activity in the life-cycle of a software project. After a newly reported bug is assigned to a developer, the developer should thoroughly analyze the bug based on a description, comments, and the content of any available logfiles before changing source code in an attempt to fix the bug. While analysis is crucial it can also be very time-consuming. For an engineer unfamiliar with the source code, analysis can be very expensive. Additionally, given modular coding techniques, a particular defect can manifest itself in a number of software files or even in particular areas of software files.

A software bug occurs when an application or program doesn't work the way it is designed to function. Many errors are faults or mistakes made by system architects, designers, or developers. Testing teams use bug tracking to monitor and report on errors that occur as an application is developed and tested. A major component of a bug tracking system is a database that records facts about known bugs. Facts may include the time a bug was reported, its severity, the erroneous program behavior and details on how to reproduce the bug, as well as the identity of the person who reported it and any programmers who may be fixing it.

Many organizations rely on defect tracking tools, or bug tracking tools, to manage the software development, quality assurance, and production processes, along with software versioning systems to manage changes to software source code. Often, software defects are discovered that, in hindsight, are similar to previously resolved defects. However, current bug tracking tools provide little or no ability to correlate new bugs with previously fixed bugs (and the basis of their resolution) or with the actual software changes that were made. During its lifetime, a single defect may go through several stages or states. They can include Active—Investigation is underway; Test—Fixed and ready for testing; Verified—Retested and verified by quality assurance (QA); Closed—Can be closed after QA retesting or if it is not considered to be a defect; and Reopened—Not fixed and reactivated.

Bugs can be managed based on priority and severity. Severity levels help to identify the relative impact of a problem on a product release. These classifications may vary in number, but they generally include some form of the following: Catastrophic—Causes total failure of the software or unrecoverable data loss. There is no workaround and the product can't be released; Impaired functionality—A workaround may exist, but it is unsatisfactory. The software can't be released; Failure of non-critical systems—A reasonably satisfactory workaround exists. The product may be released, if the bug is documented; Very minor—There is a workaround, or the issue can be ignored. It does not impact a product release.

In many cases, states and severity levels are monitored in a bug tracking database. Some tracking platforms also tie into larger software development and management systems, to better assess error status and the potential impact on overall production and timelines.

Software defects can be expensive to repair, particularly if the defect involves multiple software files (and multiple locations within those software files) and the defect manifests itself in a production environment and results in a customer's outage or impaired operations. The speed and efficiency with which defects are resolved can directly transfer to an organization's bottom line.

In many bug tracking tools, developers identify a root cause of a bug. They may also record details of the fix. Often, these details appear in the description, along with comments and extracts of the contents of logfiles associated with the defect. In some embodiments, the details of the defect include stack traces. After the defect has been resolved and verified, additional details of the fix may be added to the bug tracking tool.

Software defects are likely an unavoidable reality for software applications. Defects also take up valuable resources during prosecution and can increase an organization's operational costs. Ultimately, defects can reduce continuous testing/integration stability, increase time-to-market, reduce developer trust, and impact developer experience.

Aspects of the present disclosure address the above-noted and other deficiencies by providing a code path autosuggestion system. Benefits of a code path autosuggestion system include saving time in an analysis phase by identifying software files or modules that likely need to be examined as part of a software fix. Additionally, an engineer with moderate domain competence can more likely resolve an issue within time and budget constraints. Furthermore, in addition to identifying software files or modules of interest, particular sections of those files can be highlighted.

As discussed in greater detail below, a code path autosuggestion system may include a collection of servers that provide one or more services to one or more client devices. The code path autosuggestion system may retrieve, from a repository, defect data associated with a software defect. Using the defect data, the code path autosuggestion system may then search a dataset for an earlier, resolved software defect, similar to the current software defect. As a result of the search, the code path autosuggestion system may determine a set of regions of source code associated with the earlier software defect. The code path autosuggestion system may then upload the set of regions of source code to the repository as candidates for patching the current software defect. In some embodiments, by providing the current defect to a machine learning model, the model can provide the output as a set of regions that include a filename and lines of code that developers may need to change. In some embodiments, this helps the developers reduce the time of an analysis phase.

Although aspects of the disclosure may be described in the context of software development, embodiments of the disclosure may be applied to any computing system that is in active use and to which software changes are being made.

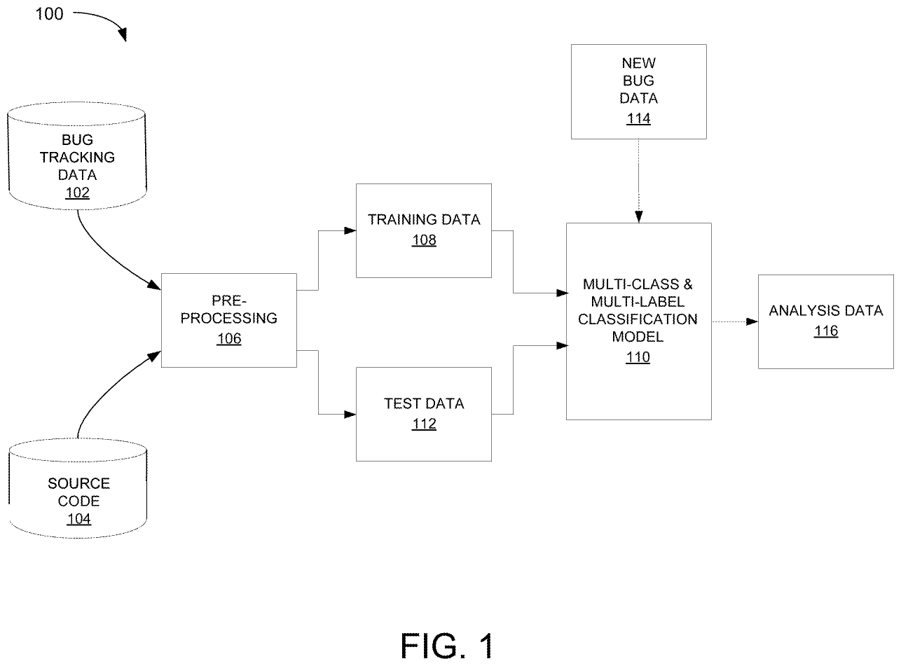

FIG. 1 is an illustrative example of a code path autosuggestion architecture 100, in accordance with some embodiments of the disclosure. However, other code path autosuggestion architectures 100 are possible, and the implementation of a computer system utilizing examples of the disclosure are not necessarily limited to the specific architecture depicted by FIG. 1. In some embodiments, the code path autosuggestion architecture takes bug tracking data 102 and source code 104 as inputs. In some embodiments, pre-processing 106 extracts a heading, description, history, and fix for each bug collected in the bug tracking data 102. In some embodiments, history may comprise comments associated with each bug. In some embodiments, the pre-processing 106 may decompose the source code 104 into sections or regions. In some embodiments, these regions may comprise methods or functions. In some embodiments, these regions may comprise a number of lines of source code, e.g., 20 lines. In some embodiments, these regions may comprise portions of methods, e.g., 20 lines. For example, a source code file of 500 lines might be divided into 25 regions of 20 lines. In some embodiments, regions may have a flexible size, e.g., a method of 25 lines may be designated as a single region. In some embodiments, code changes associated with a particular bug may be extracted from a source code repository.

In some embodiments, pre-processing 106 may comprise data cleaning. In some embodiments, data cleaning can include finding and resolving outliers, missing values, inconsistent data, and duplicate data in the bug tracking data 102. In some embodiments, data cleaning can involve converting the bug tracking data 102 into columnar data. In some embodiments, the columnar data can include description, comments, filename, and region. In some embodiments, the columnar data can include the contents of logfile entries associated with occurrences of the defect. In some embodiments, this columnar data can be used to create training data 108. In some embodiments, pre-processing can include applying natural language processing (NLP) against the bug tracking data 102. In some embodiments, the pre-processing 106 can produce training data 108, which can in turn produce a machine learning (ML) model. In some embodiments, the ML model can be instantiated as a multi-class and multi-label classification model 110. In some embodiments, labels may be filename and region. In some embodiments, labels may also be referenced as targets.

In some embodiments, bug data is incomplete and inaccurate and includes outliers that can be difficult for ML models. This can lead to suboptimal training performance. In some embodiments, duplicate rows or columns in the bug tracking data are eliminated to produce the training data 108. In some embodiments, bug data with missing values are either removed or values imputed to the missing values. In some embodiments, imputation can be performed by replacing the missing values with mean, median, or mode values. In some embodiments, imputation can be performed based on machine learning predictions.

Some ML models can be adversely impacted by outliers in the data. Thus, steps should be taken to remove them during data cleaning to obtain a better model that may use metrics such as mean squared error. After imputing missing values and resolving outliers, the data is transformed for training an ML model. Transformation can include standardization, normalization, binning, and clustering. In some embodiments, standardization can comprise a consistent region size, e.g., 20 lines of code, consistent module names, or bug types.

Normalization is another aspect of data cleaning. In some embodiments, processing logic can extract bug data from the bug tracking data and apply natural language processing (NLP) techniques to normalize textual data. In some embodiments, general modules or functions that tend to be obliquely involved in many defects may be removed or de-weighted from the raw data. Binning can involve dividing data into “bins” based on one more data values. These bins then include smaller groups of more similar data. In some cases, binning can reduce an impact of outliers on an ML model. Clustering can involve grouping data based on the value of a particular feature in order to identify patterns in the grouped data.

The cleaned training data 108 can then be converted into a structure suitable for generating a multi-class and multi-label classification model 110. In some embodiments, the new bug data is classified using a classification algorithm such as K-nearest neighbor, naive Bayes, logistic regression, decision tree, support vector machine, or random forest. In some embodiments, test data 112 can be obtained from the bug tracking data 102 and the source code 104 to provide additional inputs to the multi-class and multi-label classification model 110. In some embodiments, the test data 112 can include additional pre-processing and cleaning.

In some embodiments, new bug data 114 can be classified by the multi-class and multi-label classification model 110 to generate analysis data 116. In some embodiments, this analysis data can be in the form of hints that can guide software developers to examine regions of software that have been associated with past defects determined to be similar to current defects. In some embodiments, the new bug data is classified using a classification algorithm such as K-nearest neighbor, naive Bayes, logistic regression, decision tree, support vector machine, or random forest.

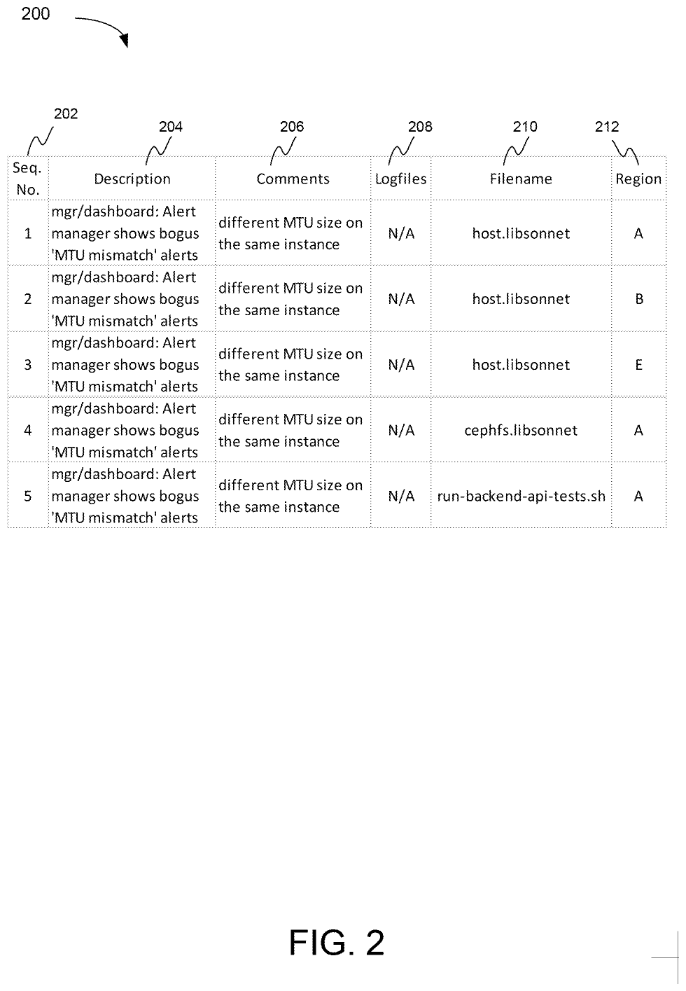

FIG. 2 is an illustrative example of a code path autosuggestion dataset 200, in accordance with some embodiments of the disclosure. In the example, the dataset is represented as a number of rows of columnar data. In the example, Seq. No. 202 represents a unique sequence number for internal organization and manipulation of the dataset. In some embodiments, Description 204 represents a description of a defect or bug. In some embodiments, the description may be normalized. In some embodiments, keyword extraction may be performed with NLP. In some embodiments, Comments 206 represents comments added by developers or QA engineers during prosecution of the defect. In some embodiments, keyword extraction and/or normalization may be performed on the comments with NLP.

Continuing with FIG. 2, in some embodiments, Logfiles 208 represents data obtained from logfiles associated with an occurrence of the defect. In some cases, there may be no logfile data associated with a bug. In some embodiments, filename 210 represents a software file that was modified as part of the fix for the bug. In some embodiments, Region 212 represents a region, or area, of the filename 210 where the fix was applied. In some embodiments, as a result of data cleaning, any duplicate records will be removed from the dataset.

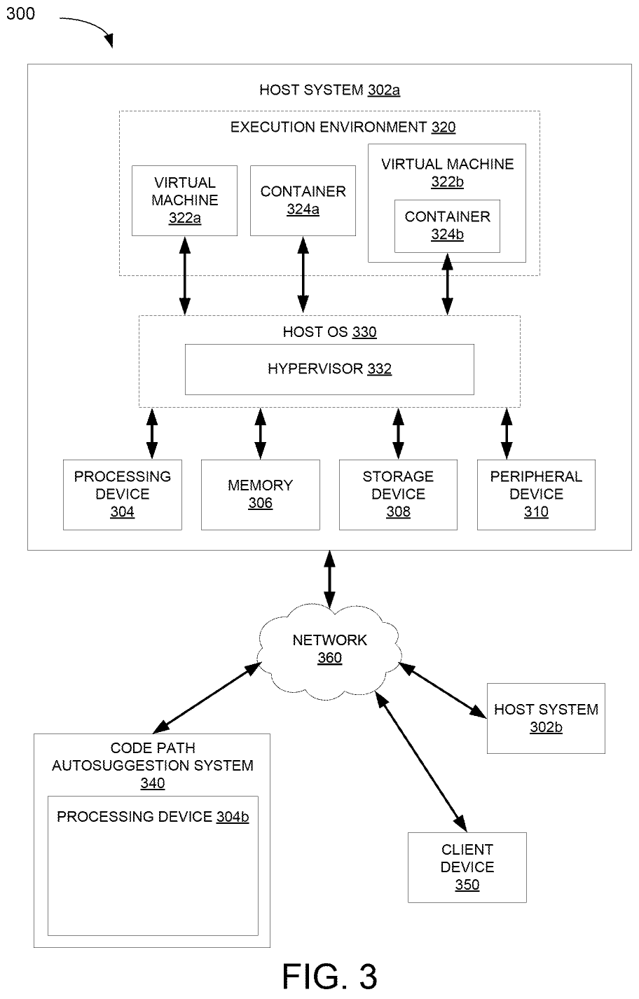

FIG. 3 is a block diagram that illustrates an example code path autosuggestion architecture 300, in accordance with some embodiments. However, other code path autosuggestion architectures 300 are possible, and the implementation of a computer system utilizing examples of the disclosure are not necessarily limited to the specific architecture depicted by FIG. 3.

As shown in FIG. 3, code path autosuggestion architecture 300 includes host systems 302a and 302b, code path autosuggestion system 340, and client device 350. In some embodiments, code path autosuggestion system 340 may correspond to code path autosuggestion architecture 100 of FIG. 1. The host systems 310a and 310b, code path autosuggestion system 340, and client device 350 include one or more processing devices 304, memory 306, which may include volatile memory devices, e.g., random access memory (RAM), non-volatile memory devices, e.g., flash memory, and/or other types of memory devices, a storage device 308, e.g., one or more magnetic hard disk drives, a Peripheral Component Interconnect (PCI) solid state drive, a Redundant Array of Independent Disks (RAID) system, or a network attached storage (NAS) array, and one or more devices 390, e.g., a Peripheral Component Interconnect (PCI) device, a network interface controller (NIC), a video card, or an I/O device. In certain implementations, memory 306 may be non-uniform access (NUMA), such that memory access time depends on the memory location relative to processing device 304. It should be noted that although, for simplicity, a single processing device 304, storage device 308, and peripheral device 310 are depicted in FIG. 3, other embodiments of host systems 302a and 302b, code path autosuggestion system 340, and client device 350 may include multiple processing devices, storage devices, or devices. Processing device 304 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 304 may also include one or more special-purpose processing devices such as an application specific integrated circuit (ASIC), a field programmable gate array (FPGA), a digital signal processor (DSP), network processor, or the like.

The host systems 302a and 302b, code path autosuggestion system 340, and client device 350 may be a server, a mainframe, a workstation, a personal computer (PC), a mobile phone, a palm-sized computing device, etc. In some embodiments, host systems 302a and 302b, code path autosuggestion system 340, and/or client device 350 may be separate computing devices. In some embodiments, host systems 302a and 302b, code path autosuggestion system 340, and/or client device 350 may be implemented by a single computing device. For clarity, some components of code path autosuggestion system 340, host system 302b, and client device 350 are not shown. In some embodiments, the code path autosuggestion system 340 may be part of a container-orchestration system. Furthermore, although code path autosuggestion architecture 300 is illustrated as having two host systems, embodiments of the disclosure may utilize any number of host systems.

Host systems 302a and 302b may additionally include execution environments 320, which may include one or more virtual machines (VMs) 322a, containers 324a, containers 322b residing within virtual machines 322b, and a host operating system (OS) 330. VM 322a and VM 322b are software implementations of machines that execute programs as though they were actual physical machines. Containers 324a and 324b act as isolated execution environments for different workloads of services, as previously described. Host OS 330 manages the hardware resources of the computer system and provides functions such as inter-process communication, scheduling, memory management, and so forth.

Host OS 330 may include a hypervisor 332, which may also be known as a virtual machine monitor (VMM), that can provide a virtual operating platform for VMs 322a and 322b and manage their execution. Hypervisor 332 may manage system resources, including access to physical processing devices, e.g., processors or CPUs, physical memory, e.g., RAM, storage devices, e.g., HDDs or SSDs, and/or other devices, e.g., sound cards or video cards. The hypervisor 332, though typically implemented in software, may emulate and export a bare machine interface to higher level software in the form of virtual processors and guest memory. Higher level software may comprise a standard or real-time OS, may be a highly stripped-down operating environment with limited operating system functionality, and/or may not include traditional OS facilities, etc. Hypervisor 332 may present other software, i.e., “guest” software, the abstraction of one or more VMs that provide the same or different abstractions to various guest software, e.g., a guest operating system or guest applications. It should be noted that in some alternative implementations, hypervisor 332 may be external to host OS 330, rather than embedded within host OS 330, or may replace host OS 330.

The host systems 302a and 302b, code path autosuggestion system 340, and client device 350 are coupled to each other, e.g., may be operatively coupled, communicatively coupled, or may send data/messages to each other, via network 360. Network 360 may be a public network, e.g., the internet, a private network, e.g., a local area network (LAN) or a wide area network (WAN), or a combination thereof. In one embodiment, network 360 may include a wired or a wireless infrastructure, which may be provided by one or more wireless communications systems, such as a WiFi™ hotspot connected with the network 360 and/or a wireless carrier system that can be implemented using various data processing equipment, communication towers, e.g., cell towers. The network 360 may carry communications, e.g., data, message, packets, or frames, between the various components of host systems 302a and 302b, code path autosuggestion system 340, and/or client device 350.

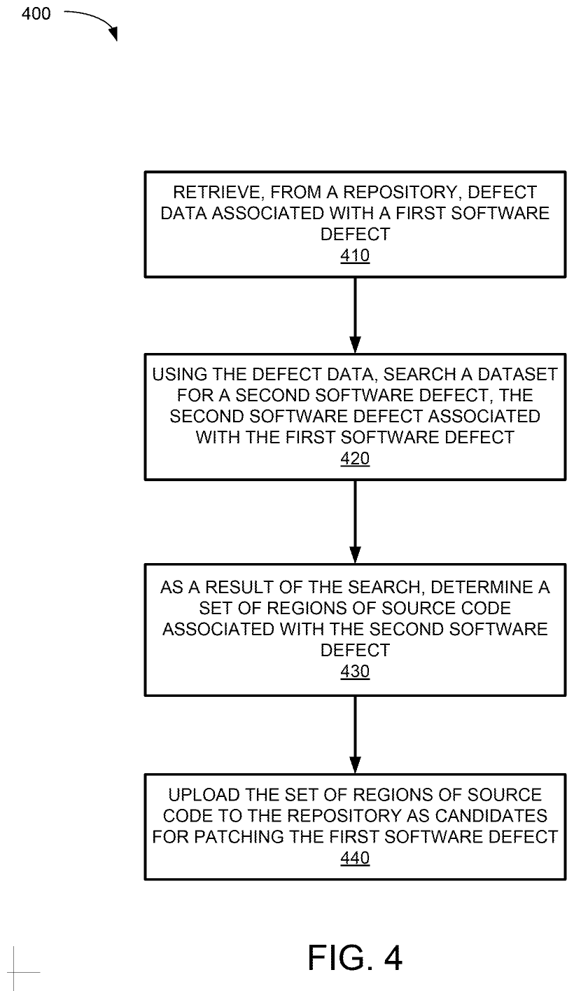

In some embodiments, host system 302a may support a code path autosuggestion system 340. The code path autosuggestion system 340 may receive a request from an application executing in container 324a to send a message to an application executing in container 324b. The code path autosuggestion system 340 may identify communication endpoints for execution environment(s) to support communication with host system 302a and/or host system 302b. The code path autosuggestion system 340 may configure the network connections to facilitate communication between the execution environment(s) and/or the client device 350. Further details regarding code path autosuggestion system 340 will be discussed as part of the description of FIGS. 4-6 below.

FIG. 4 is a flow diagram of an example method 400 of code path autosuggestion, in accordance with some embodiments of the disclosure. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by code path autosuggestion architecture 100 of FIG. 1.

With reference to FIG. 4, method 400 illustrates example functions used by various embodiments. Although specific function blocks (“blocks”) are disclosed in method 400, such blocks are examples. That is, examples are well suited to performing various other blocks or variations of the blocks recited in method 400. It is appreciated that the blocks in method 400 may be performed in an order different than presented, and that not all of the blocks in method 400 may be performed.

Method 400 begins at block 410, where the processing logic causes the code path autosuggestion system to retrieve defect data associated with a first software defect. In some embodiments, this defect data may correspond to new bug data 112 of FIG. 1. In some embodiments, the defect data may include a description of a bug, comments associated with the discovery of the defect, the contents of logfiles associated with an occurrence of the defect, or other metrics available from a bug tracking system. In some embodiments, the bug tracking system may be comparable to the bug tracking data 102 of FIG. 1. In some embodiments, the new bug data may be subsequently added to a repository, such as the bug tracking data 102 of FIG. 1. In some embodiments, the defect data may be processed with NLP techniques to normalize the data and perform keyword extraction on the description, comments, and the contents of logfiles associated with the defect data.

At block 420, using the defect data, the processing logic searches a dataset for a second software defect, the second software defect associated with the first software defect. In some embodiments, the dataset is a multi-class and multi-label classification model such as multi-class and multi-label classification model 110 of FIG. 1. In some embodiments, the dataset is trained using machine learning. In some embodiments, the first and second software defects are classified using a classification algorithm such as K-nearest neighbor, naive Bayes, logistic regression, decision tree, support vector machine, or random forest.

At block 430, as a result of the search, the processing logic determines a set of regions of source code associated with the second software defect. In some embodiments, the regions comprise portions of software files. In some embodiments, these portions of software files were modified to resolve the second software defect. In some embodiments, these regions may comprise methods or functions. In some embodiments, these regions may comprise a number of lines of source code, e.g., 20 lines. In some embodiments, these regions may comprise portions of methods, e.g., 20 lines. In some embodiments, regions may have a flexible size, e.g., a method of 25 lines may be designated as a single region.

At block 440, the processing logic uploads the set of regions of source code to the repository as candidates for patching the first software defect. In some embodiments, the processing logic may further provide the descriptions, comments, and logfile information associated with the second software defect. In some embodiments, the processing logic may provide a set of regions that comprises multiple software files. In some embodiments, by providing the current defect to a machine learning model, the model can provide the output as a set of regions that include a filename and lines of code that developers may need to change. In some embodiments, this helps the developers reduce the time of an analysis phase.

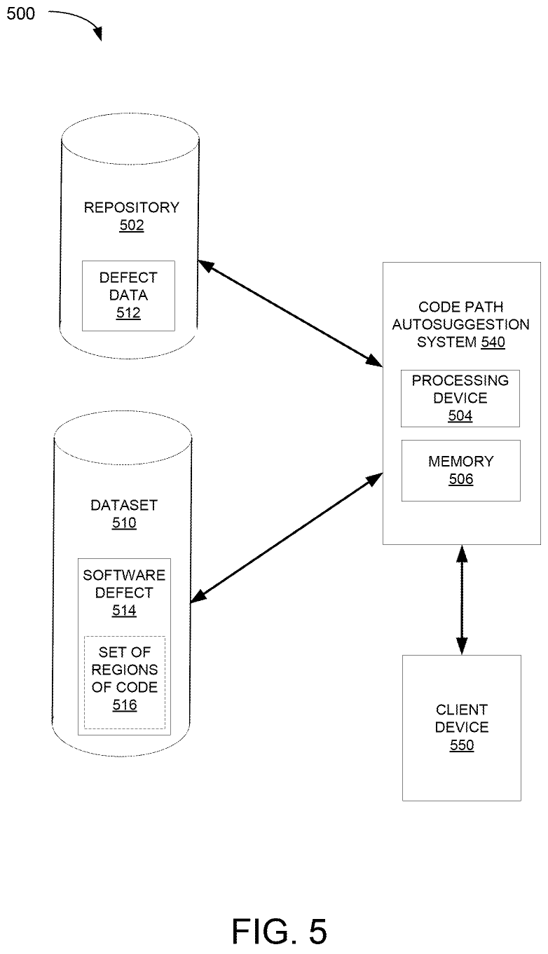

FIG. 5 is a block diagram depicting an example environment 500 for a code path autosuggestion architecture, in accordance with some embodiments. The example environment 500 includes code path autosuggestion system 540. Code path autosuggestion system 540, which may correspond to code path autosuggestion system 340 of FIG. 3, contains processing device 504 and memory 506. Example environment 500 also includes client device 550, which may correspond to client device 350 of FIG. 3. Example environment 500 also includes repository 502, which contains defect data 512. Repository 502 may correspond to repository 102 of FIG. 1. Example environment 500 also includes dataset 510, which may correspond to multi-class and multi-label classification model 110 of FIG. 1. Dataset 510 also includes software defect 514 and region of code 516. It should be noted that defect data 512, software defect 514, and region of code 516 are shown for illustrative purposes only and are not physical components of code path autosuggestion system 500.

The processing device 504 retrieves, from a repository 502, defect data 512 associated with a first software defect. In some embodiments, the first software defect corresponds to new bug data 114 of FIG. 1. Using the defect data, the processing device 504 searches a dataset 510 for a second software defect 514, the second software defect 514 associated with the first software defect. As a result of the search, processing device 504 determines a set of regions of source code 516 associated with the second software defect 514. The processing device 504 uploads the set of regions of source code 516 to the repository as candidates for patching the first software defect. In some embodiments, the set of regions of source code 516 are provided to a developer by way of a client device 550. In some embodiments, client device 550 corresponds to client device 350 of FIG. 3. In some embodiments, by providing the current defect to a machine learning model, the model can provide the output as a set of regions that include a filename and lines of code that developers may need to change. In some embodiments, this helps the developers reduce the time of an analysis phase.

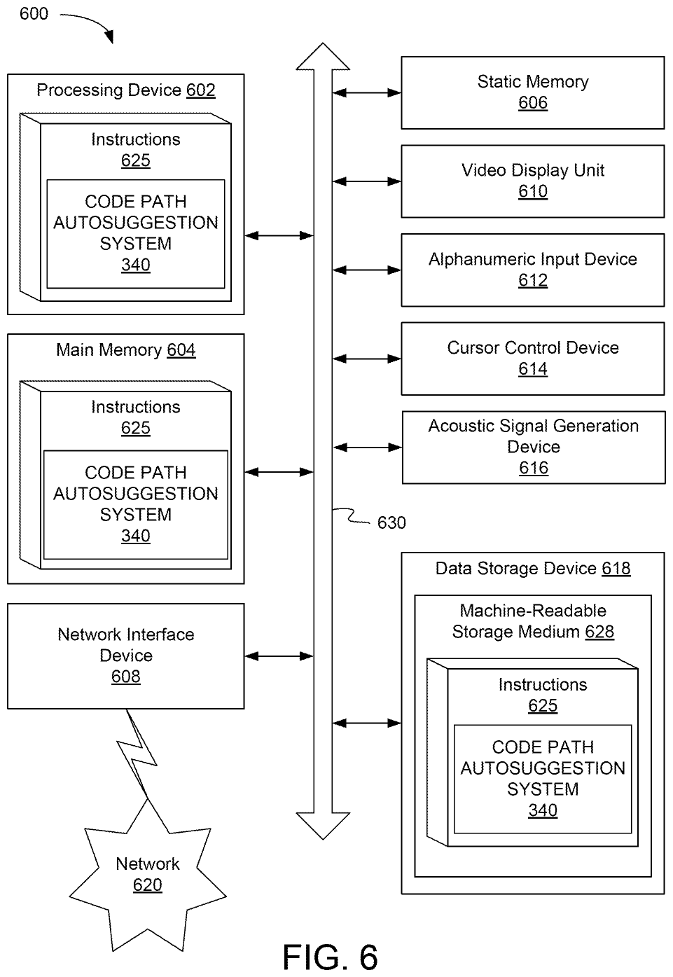

FIG. 6 is a block diagram of an example computing device 600 that may perform one or more of the operations described herein, in accordance with some embodiments of the disclosure. Computing device 600 may be connected to other computing devices in a LAN, an intranet, an extranet, and/or the Internet. The computing device may operate in the capacity of a server machine in a client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 600 may include a processing device 602, e.g., a general-purpose processor, a programmable logic device (PLD), a main memory 604, e.g., synchronous dynamic random-access memory (DRAM), read-only memory (ROM), static memory 606, e.g., flash memory, and a data storage device 618, which may communicate with each other via a bus 630.

Processing device 602 may be provided by one or more general-purpose processing devices such as a microprocessor, central processing unit, or the like. In an illustrative example, processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also include one or more special-purpose processing devices such as an application specific integrated circuit (ASIC), a field programmable gate array (FPGA), a digital signal processor (DSP), network processor, or the like. The processing device 602 may be configured to execute the operations described herein, in accordance with one or more aspects of the present disclosure, for performing the operations and steps discussed herein.

Computing device 600 may further include a network interface device 608 that may communicate with a network 620. The computing device 600 also may include a video display unit 610, e.g., a liquid crystal display (LCD) or a cathode ray tube (CRT), an alphanumeric input device 612, e.g., a keyboard, a cursor control device 614, e.g., a mouse, and an acoustic signal generation device 616, e.g., a speaker. In one embodiment, video display unit 610, alphanumeric input device 612, and cursor control device 614 may be combined into a single component or device, e.g., an LCD touch screen.

Data storage device 618 may include a computer-readable storage medium 628 on which may be stored one or more sets of instructions 625 that may include instructions for a code path autosuggestion system 240 for carrying out the operations described herein, in accordance with one or more aspects of the present disclosure. In some embodiments, the code path autosuggestion system 240 may correspond to the code path autosuggestion architecture 240 of FIG. 2. Instructions 625 may also reside, completely or at least partially, within main memory 604 and/or within processing device 602 during execution thereof by computing device 600, main memory 604 and processing device 602 also constituting computer-readable media. The instructions 625 may further be transmitted or received over a network 620 via network interface device 608.

While computer-readable storage medium 628 is shown in an illustrative example to be a single medium, the term “computer-readable storage medium” should be taken to include a single medium or multiple media, e.g., a centralized or distributed database and/or associated caches and servers, that store the one or more sets of instructions. The term “computer-readable storage medium” shall also be taken to include any medium capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “receiving,” “retrieving,” “performing,” “determining,” “comparing,” “updating,” “sending,” or the like, refer to actions and processes performed or implemented by computing devices that manipulate and transform data, represented as physical (electronic) quantities within the computing device's registers and memories, into other data similarly represented as physical quantities within the computing device memories or registers or other such information storage, transmission, or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to a particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, and do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times, or the described operations may be distributed in a system that allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure, e.g., circuitry, that performs the task or tasks during operation. As such, the unit/circuit/component can be said to be configured to perform the task, or configurable to perform the task, even when the specified unit/circuit/component is not currently operational, e.g., is not on. The units/circuits/components used with the “configured to” or “configurable to” language include hardware, e.g., circuits, memory storing program instructions executable to implement the operation, etc. Reciting that a unit/circuit/component is “configured to” perform one or more tasks, or is “configurable to” perform one or more tasks, is expressly intended to not invoke 35 U.S.C. § 112, sixth paragraph, for that unit/circuit/component. Additionally, “configured to” or “configurable to” can include generic structure, e.g., generic circuitry, that is manipulated by software and/or firmware, e.g., an FPGA or a general-purpose processor executing software, to operate in a manner that is capable of performing the task(s) at issue. “Configured to” may also include adapting a manufacturing process, e.g., a semiconductor fabrication facility, to fabricate devices, e.g., integrated circuits, that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
retrieving, from a repository, defect data associated with a first software defect;
using the defect data, searching a dataset for a second software defect, the second software defect associated with the first software defect;
as a result of the search, determining a set of regions of source code associated with the second software defect; and
uploading the set of regions of source code to the repository as candidates for patching the first software defect.

2. The method of claim 1, wherein the repository comprises a bug tracking system.

3. The method of claim 1, wherein the defect data comprises at least one of:
descriptions;
comments; or
logfile contents.

4. The method of claim 1, wherein the dataset comprises a multi-class and multi-label classification model.

5. The method of claim 4, wherein the dataset is trained using a machine language algorithm.

6. The method of claim 1, wherein each region of the set of regions of source code comprises a same number of lines of source code.

7. The method of claim 1, wherein searching the dataset comprises applying natural language processing techniques against the defect data associated with the first software defect.

8. A system, comprising:
a memory; and
a processing device, operatively coupled to the memory, to:
retrieve, from a repository, defect data associated with a first software defect;
using the defect data, search a dataset for a second software defect, the second software defect associated with the first software defect;
as a result of the search, determine a set of regions of source code associated with the second software defect; and
upload the set of regions of source code to the repository as candidates for patching the first software defect.

9. The system of claim 8, wherein the dataset is classified using at least one of
K-nearest neighbor;
naive Bayes;
logistic regression;
decision tree;
support vector machine; or
random forest.

10. The system of claim 8, wherein the defect data is translated with natural language processing.

11. The system of claim 8, wherein the dataset comprises references to source code files divided into regions.

12. The system of claim 8, wherein the dataset comprises a multi-class and multi-label classification model.

13. The system of claim 12, wherein the dataset is multi-target and comprises targets of filename; and region.

14. A non-transitory computer-readable storage medium including instructions that, when executed by a processing device, cause the processing device to:
retrieve, from a repository, defect data associated with a first software defect;
using the defect data, search a dataset for a second software defect, the second software defect associated with the first software defect;
as a result of the search, determine a set of regions of source code associated with the second software defect; and
upload the set of regions of source code to the repository as candidates for patching the first software defect.

15. The non-transitory computer-readable storage medium of claim 14, wherein the repository comprises a bug tracking system.

16. The non-transitory computer-readable storage medium of claim 14, wherein the defect data comprises at least one of:
descriptions;
comments; or
logfile contents.

17. The non-transitory computer-readable storage medium of claim 14, wherein the dataset comprises a multi-class and multi-label classification model.

18. The non-transitory computer-readable storage medium of claim 14, wherein the dataset is classified using at least one of
K-nearest neighbor;
naive Bayes;
logistic regression;
decision tree;
support vector machine; or
random forest.

19. The non-transitory computer-readable storage medium of claim 14, wherein the instructions further cause the defect data to be translated with natural language processing.

20. The non-transitory computer-readable storage medium of claim 14, wherein the dataset comprises references to source code files divided into regions.
